(19) United States
(12) Patent Application Publication
(10) Pub. No.: US 2007/0076236 A1
(43) Pub. Date: Apr. 5, 2007

(54) Print system, image processing apparatus, image processing method, and printer driver program thereof

(75) Inventor: Masateru Mitani, Sunto-gun (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/243,073

(22) Filed: Oct. 3, 2005

(51) Int. Cl. G06F 3/12

(52) U.S. Cl. 358/1.13; 358/1.15

(57) ABSTRACT

An image forming system having a server apparatus disposed on a network, a printer disposed on the network, an image processing apparatus disposed on the network, and a printer driver program including means for installing the printer driver program on the server apparatus together with a file containing address information on the printer on the network, means for downloading the printer driver program in the image processing apparatus together with the file containing the address information via communications with the server apparatus from the image processing apparatus, and means for accessing to the printer from the image processing apparatus based on the address information, so as to execute a printing job on the printer.

### BACKGROUND OF THE INVENTION

The invention relates to a network system and, more particularly, to a print system, an image processing apparatus and an image processing method, which use a program for forming a network address of a printer in the form of a file, and a printer driver program thereof.

In recent years, there has been generally used a system in which a client PC allows a printer on a network to execute a printing job in a network system managed by a network server as a digital network is more prevailed. In such a network printer system, setting information on the printer (such as a type of a finisher installed or a size of sheets stacked in each of cassettes) need be previously set for a printer driver on the client PC before the printing job is executed, and heretofore, a user need individually set the printer when the user installs the printer driver on the PC. As a prior art in which the above-described operation is automated (as disclosed in Jpn. Par. Appln. KOKAI Publication No. 2000-330,742), there has been known a method which registers a network address (e.g., an IP address) on a network server (i.e., a printer information server) in addition to a printer name and a printer driver, so as to notify a client PC of the network address of the printer when the printer driver is installed on the client PC.

However, in the above-described network system, some of network servers may not include any means for notifying the client PC of the network address in case of using a network server generally used such as the NetWare by Novell. As a consequence, the above-described prior art has raised a problem that a printer information server need be additionally constructed.

### BRIEF SUMMARY OF THE INVENTION

According to one embodiment of the present invention, there is provided an image forming system has: a server apparatus disposed on a network; a printer disposed on the network; an image processing apparatus disposed on the network; and a printer driver program having: means for installing the printer driver program on the server apparatus together with a file containing address information on the printer disposed on the network; means for downloading the printer driver program in the image processing apparatus together with the file containing the address information via communications with the server apparatus from the image processing apparatus; and means for accessing to the printer from the image processing apparatus based on the address information, so as to execute a printing job on the printer.

### BRIEF DESCRIPTION OF THE SEVERAL VIEWS OF THE DRAWING

FIG. 1 is a block diagram illustrating one example of a network for a print system, to which a printer driver program in a preferred embodiment according to the invention is applied;

FIG. 2 is a diagram illustrating one example of constituting the printer driver program in the preferred embodiment according to the invention;

FIG. 3 is a diagram illustrating a description example of address.xml for the printer driver program in the preferred embodiment according to the invention;

FIG. 4 is a diagram illustrating one example of a screen, on which the configuration of a printer is set for a printer driver, of the printer driver program in the preferred embodiment according to the invention;

FIG. 5 is a flowchart illustrating one example of an installing processing of the printer driver program on a server apparatus in the preferred embodiment according to the invention;

FIG. 6 is a flowchart illustrating one example of a downloading processing of the printer driver program to a client PC in the preferred embodiment according to the invention; and

FIG. 7 is a flowchart illustrating one example of an updating processing by the printer driver program in the preferred embodiment according to the invention.

### DETAILED DESCRIPTION OF THE INVENTION

A detailed description will be given below of a printer driver program, and a print system, an image processing apparatus and an image processing method, which use the printer driver program, in a preferred embodiment according to the invention in reference to the attached drawings.

<Print System, to Which Printer Driver Program in Preferred Embodiment According to Invention is Applied>

(Configuration)

First of all, a detailed description will be given below or a configuration or a print system, to which a printer driver program in a preferred embodiment according to the invention is applied, in reference to FIG. 1. FIG. 1 illustrates a state in which one network server, two printers and three client PCs are connected to each other via a network such as the Ethernet. In FIG. 1, a print system, to which the printer driver program in the preferred embodiment according to the invention is applied, has a network server S connected to a network N, printers P1 and P2 such as a multiple functional printer (abbreviated as “an MFP”) connected to the network N, and client PCs 21, 22 and 23 also connected to the network N. Here, the client PC 21 has a communicator 12 for performing communications with the network server S and the like via the network N, a memory 13 such as a hard disk driver, and a controller 14 such as a CPU, a register or a basic program.

The above-described print system, which utilizes a conventional network, has raised an inconvenience that in the case where the client PC cannot get a network address of a printer, a special printer information server need be additionally constructed, and then, the network address of the printer need be supplied to the client PC.

To the contrary, with the printer driver program in the preferred embodiment according to the invention, even in the case where the network server does not include any means for notifying the client PC of the network address, the client PC can be notified of the network address of the printer. As a consequence, it is possible to remove a burden or additional construction of a special network server (i.e., a printer information server).

(Printer Driver Program in Preferred Embodiment According to Invention)

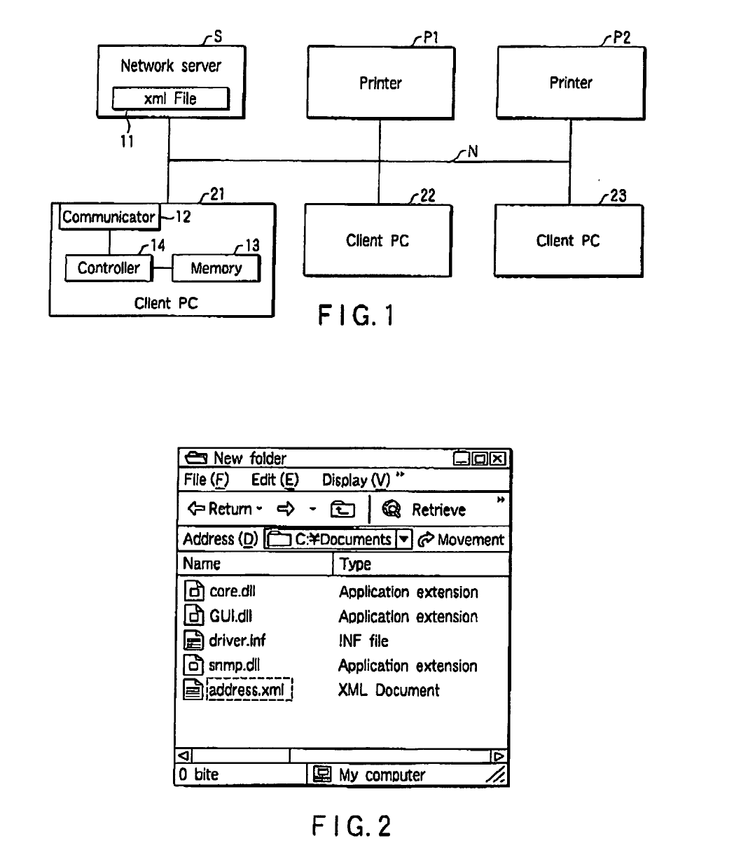

First, explanation will be made on the printer driver program for dispensing with the construction of a special network server (i.e., a printer information server) in the preferred embodiment according to the invention. FIG. 2 is a diagram illustrating a list of filed which constitute a printer driver for the Windows OS, for example.

Here, “core.dll” is a file having a function of receiving image data from an application or OS plotting function so as to convert it into a printer description language (abbreviated as “a CDL”). “GUI.dll” is a file having a function of managing a printer driver GUI. The file “core.dll” is notified of information, which is set on the GUI by a user, as appropriate. “driver.inf” is a file, on which information required for installing the printer driver on the OS is described. “snmp.dll” is a file for providing a function for the printer driver to communicate with the printer by the use or a simple network management protocol (abbreviated as “an SNMP”).

“address.xml” is a file peculiar to the present preferred embodiment, and is a file describing network address information on the printer. Incidentally, although the format of the file “address.xml” is of XML format in the present preferred embodiment, it may be of INI, TXT or any other file formats.

Although the above description has been limited to the typical files constituting the printer driver, it may be preferable that the number of constitution files should be actually increased according to the functions provided by the printer driver.

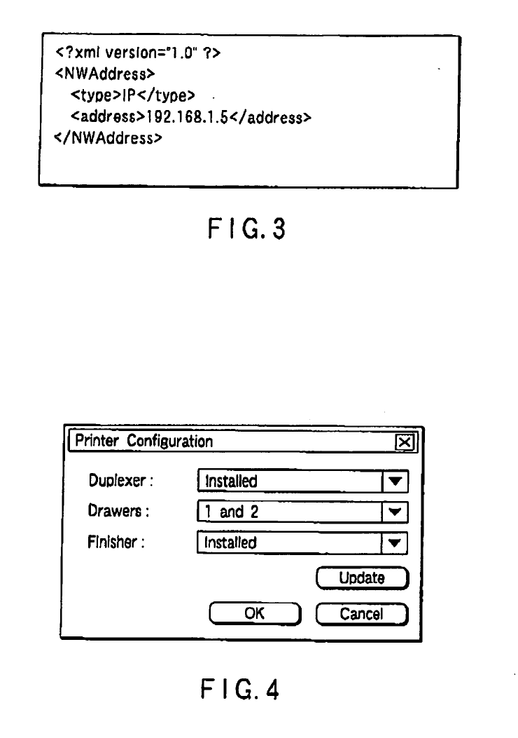

FIG. 3 is a diagram illustrating a description example of address.xml. In this example, the network address or the printer is defined by a value of 192.168.1.5 in the format of an IP address. In other words:

<?xml version=“1.0”?> signifies a version of XML used inside of an XML file;

<type>IP</type> signifies that an address format is an IP address format; and

<address>192.168.1.5</address> signifies that an address is 192.168.1.5.

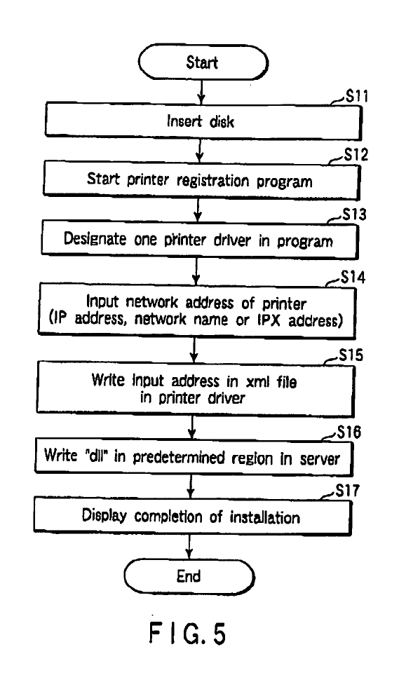

FIG. 4 is a diagram illustrating an example of a setting screen, on which the configuration of the printer is sot for the printer driver. On this setting screen, it can be set whether or not a duplexer (i.e., a double-sided copying machine) is installed, how a drawer (i.e., a sheet cassette) is mounted, and whether or not a finisher is installed.

On this setting screen, a user can manually set each of items. In addition, the printer driver can acquire required constitution information from the printer via SNMP communications by clicking an “Update” button, so that the contents of the screen can be automatically updated.

(Explanation of Operation in Accordance with Flowcharts)

A detailed description will be given below of a processing operation in accordance with the printer driver program in the preferred embodiment according to the invention in reference to flowcharts.

First of all, explanation will be made on processing when the printer driver program in the preferred embodiment according to the invention is installed on the network server S or the like in reference to a flowchart illustrated in FIG. 5.

For example, the printer driver program in the preferred embodiment according to the invention is stored in a recording medium such as a compact disk (abbreviated as “a CD”) packed with a casino of the MFP such as the printer P1, and then, is supplied to the user. However, the way of supply with printer driver program is not limited to such a way: for example, the printer driver program may be supplied on a site provided by a maker on the Internet.

Otherwise, in another preferred embodiment, the printer driver program is previously connected to a communicator, not illustrated, in the printer P1, and then, it is preferable that the printer driver program is readily or automatically installed on, for example, the network server S when the printer is connected to the network.

Installation on Network Server

For example, the CD having the printer driver program stored therein is inserted into a disk driver of the network server S by operation by a user, and then, the printer driver program is read out (step S11). A printer registration program stored in the disk is started (step S12). The printer driver program is started by the effect of a controller of the disk driver S, and then, one of the printer drivers in the program is designated in accordance with the operation by the user on an operational screen of the program (step S13).

On the network server S, for example, a network address (specifically, an IP address, a network name, an IPX address or the like) of the printer P1 is input by the operation by the user (stop S14). This input address is written in an xml file stored in a memory region inside of the network server S by the effect of the printer registration program (step S15). Furthermore, “dll” is written in the memory region inside of the network server S by the effect of the printer registration program (step S16). Finally, the completion of the installation is displayed on a display screen of the network server S (step S17).

In this manner, the printer driver program in the preferred embodiment according to the invention is installed on the network server S, and at the same time, the network address (specifically, a IP address, a network name, an IPX address or the like) of the printer P1 on the network for use in a printing operation is stored in the memory region an the xml file 11.

Download to Client PC

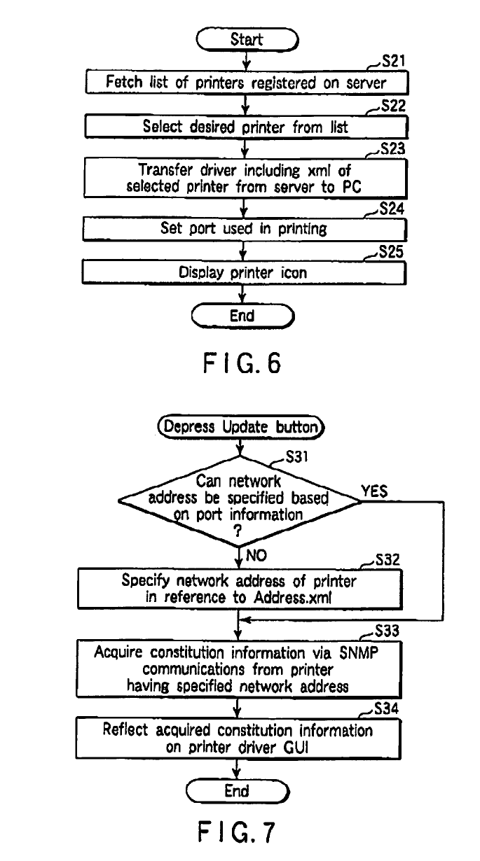

Subsequently, explanation will be made on a downloading processing of the printer driver program installed in the above-described manner in the preferred embodiment according to the invention to the client PC in reference to a flowchart illustrated in FIG. 6.

In accordance with the operation by the user, the client PC 21, for example, accesses to the network server S via the communicator 21 and the network N. Here, a list of printers registered on the network server S is fetched (step S21). The user selects a desired printer from the list of printers displayed on the screen of the client PC 21 (step S22). Printer driver files including the xml file 11 of the selected printer are transferred from the network server S to the client PC 21 via the network N (step S23). Furthermore, a port used in printing in accordance with the selected printer is set (step S24). Finally, a printer icon is displayed on the screen in order to indicate that the printer driver is downloaded and a printing operation can be performed (step S25).

In this state, since the xml file 11 is stored in the memory 13 in the client PC 21, the user need not input the IP address or the like of the printer P1 or the like on the network every time. Consequently, even a user who does not have sufficient knowledge or experience as to the technique of the network need not call a network administrator to make him input the IP address or the like. Thus, it is possible to readily set environment in which the printer P1 or P2 on the network can perform the printing operation.

Updating Processing

Additionally, with the function of the printer driver program in the preferred embodiment according to the invention, an updating processing can be performed for acquiring current constitution information or the like on a current printer. As a consequence, it is possible to perform a precise printing processing by utilizing this constitution information on the printer.

That is to say, in reference to a flowchart illustrated in FIG. 7, a user depresses the update button on the setting screen, as illustrated in FIG. 4. First of all, the printer driver program tries to specify the network address of the printer based on printer port information set in the client PC. If the printer driver can specify the network address or the printer, it performs SNMP communications with the printer having the specified network address, and then acquires constitution information.

In contrast, if the network address cannot be specified based on the port information (step S31), the network address of the printer is specified in reference to the address.xml stored in the memory region (step S32).

Thereafter, the constitution information is acquired from the printer P1 or the like having the network address specified in the xml file via the SNMP communications (step S33). Here, the constitution information is information as to sheets of which size are stacked in each of a plurality of sheet cassettes at present, for example. The constitution information acquired in the above-described manner is reflected on the printer driver GUI (step S34).

In this manner, the address information on the printer on the network, which has not been conventionally got in the client PC, can be automatically acquired from the network server. Thus the constitution information, for example, also can be readily updated even by a user who does not have any knowledge of the network.

As described in detail in reference to the attached drawings, with the printer driver program in the preferred embodiment according to the invention, device information on the printer can be acquired without retrieving the printer from the client PC even in the environment in which the network server having a high versatility such as the NetWare by Novell is used. Consequently, even a user who does not have any special network knowledge can readily set for the printing processing from the printer on the network without any help from the network administrator.

Those in the art can implement the invention by way of the above-described various preferred embodiments, and further, those in the art can readily devise various modifications of the preferred embodiment, that is to say, and can apply the invention to various preferred embodiments even without any inventive ability. Thus, the invention covers a wide scope consistent with the disclosed principle and the novel features, and therefore, it is not limited to the above-described preferred embodiments.

What is claimed is:

1. An image forming system comprising:
a server apparatus disposed on a network;
a printer disposed on the network;
an image processing apparatus disposed on the network; and
a printer driver program having:
means for installing the printer driver program on the server apparatus together with a file containing address information on the printer disposed on the network;
means for downloading the printer driver program in the image processing apparatus together with the file containing the address information via communications with the server apparatus from the image processing apparatus; and
means for accessing to the printer from the image processing apparatus based on the address information, so as to execute a printing job on the printer.

2. An image forming system according to claim 1, further comprising:
means for accessing to the printer from the image processing apparatus based on the address information contained in the file, so as to acquire management information on the printer, thus storing the management information in a memory region in the image processing apparatus.

3. An image forming system according to claim 2, further comprising:
means for displaying, on a screen of the image processing apparatus, a setting screen for acquiring the management information on the printer and for setting a function of the printer.

4. An image forming system according to claim 1, wherein the address information is any one of a network name, an IP address and an IPX address of the printer.

5. An image forming system according to claim 1, wherein the file is an xml file.

6. An image processing apparatus connected to a server apparatus and a printer, which are disposed on a network, via the network, comprising:
a communicator which performs communications with the server apparatus and the printer on the network;
a memory which stores information; and
a processor which downloads, from the server apparatus, a printer driver program installed on the server apparatus together with a file containing address information on the printer on the network via communications by the communicator, installs the printer driver program on the memory together with the file containing the address information, and accesses to the printer from the image processing apparatus based on the address information via the communications by the printer driver program and the communicator, so as to execute a printing job on the printer.

7. An image processing apparatus according to claim 6, further comprising:
means for accessing to the printer from the image processing apparatus via the communications by the communicator based on the address information contained in the file, so as to acquire management information on the printer, thus storing the management information in the memory.

8. An image processing apparatus according to claim 7, further comprising:
means for displaying, on a screen of the image processing apparatus, a setting screen for acquiring the management information on the printer and for setting a function of the printer.

9. An image processing apparatus according to claim 6, wherein the address information is any one or a network name, an IP address and an IPX address of the printer.

10. An image processing apparatus according to claim 6, wherein the file is an xml file.

11. An image processing method performed in an image processing apparatus connected to a server apparatus and a printer, which are disposed on a network, via the network, the image processing method comprising:
downloading, in the image processing apparatus, which has a communicator which performs communications with the server apparatus and the printer disposed on the network and has a memory which stores information and a processor, from the server apparatus, a printer driver program installed on the server apparatus together with a file containing address information on the printer on the network via communications by the communicator;
installing the printer driver program on the memory together with the file containing the address information; and
accessing to the printer from the image processing apparatus based on the address information via the communications by the printer driver program and the is communicator, so as to execute a printing job on the printer.

12. An image processing method according to claim 11, further comprising:
accessing to the printer from the image processing apparatus via the communications by the communicator based on the address information contained in the file, so as to acquire management information on the printer, thus storing the management information in the memory.

13. An image processing method according to claim 12, further comprising:
displaying, on a screen of the image processing apparatus, a setting screen for acquiring the management information on the printer and setting a function of the printer.

14. An image processing method according to claim 11, wherein the address information is any one of a network name, an IP address and an IPX address of the printer.

15. An image processing method according to claim 11, wherein the file is an xml file.

16. A printer driver program installed on each or a server apparatus and an image processing apparatus connected to a printer via a networks the printer driver program comprising:
means for installing the printer driver program on the server apparatus together with a file containing is address information on the printer on the network;
means for downloading the printer driver program in the image processing apparatus together with the file containing the address information from the server apparatus via the network via communications with the server apparatus from the image processing apparatus; and
means for accessing to the printer from the image processing apparatus based on the address information, so as to execute a printing job on the printer.

17. A printer driver program according to claim 16, further comprising:
means for accessing to the printer from the image processing apparatus based on the address information contained in the file, so as to acquire management information on the printer, thus storing the management information in a memory region in the image processing apparatus.

18. A printer driver program according to claim 17, further comprising:
means for displaying, on a screen of the image processing apparatus, a setting screen for acquiring the management information on the printer and setting a function of the printer.

19. A printer driver program according to claim 16, wherein the address information is any one of a network name, an IP address and an IPX address of the printer.

20. A printer driver program according to claim 16, wherein the file is an xml file.
